(19) United States
(12) Patent Application Publication
(10) Pub. No.: US 2013/0207006 A1
(43) Pub. Date: Aug. 15, 2013

(54) Measuring Transducer for Detecting the Formation of Foam on a Liquid

(71) Applicant: Christoph Weiler, Bretten (DE)

(72) Inventor: Christoph Weiler, Bretten (DE)

(73) Assignee: Siemens Aktiengesellschaft, Muenchen (DE)

(21) Appl. No.: 13/521,920

(22) PCT Filed: Jan. 13, 2010
(86) PCT No.: PCT/EP10/50325

§ 371 Date: Sep. 14, 2012

(51) Int. Cl. G01J 1/18

(52) U.S. Cl. CPC G01J 1/18
USPC 250/564

(57) ABSTRACT

A measuring transducer for detecting the formation of foam on a liquid, which is movably inserted into the liquid and the density of which is predetermined, or can be set, such that the measuring transducer floats on the surface of the liquid, wherein a device for determining the luminous flux incident on the top side of the measuring transducer is provided to detect the formation of foam on the liquid which, in many cases, is a process sequence property that is important for process optimization, and wherein an evaluation device of the measuring transducer is configured to output a signal for indicating the formation of the foam when the light flux determined undershoots a predefined threshold value.

### CROSS-REFERENCE TO RELATED APPLICATIONS

This is a U.S. national stage of application No. PCT/EP2010/050325 filed 13 Jan. 2010.

### BACKGROUND OF THE INVENTION

1. Field of the Invention

The invention relates to a measuring transducer for detecting the formation of foam on a liquid, which can be placed movably in the liquid and the density of which is predetermined or adjustable such that the transducer floats on the surface of the liquid.

2. Description of the Related Art

In process technology plants of the chemical, pharmaceutical, biochemical or food industries, it is customary to use measuring transducers to determine physical or chemical properties of the process medium, which need to be fastened to containers or pipes containing media by elaborate flanges or penetrations. This, however, has the disadvantage that a measuring transducer can only determine the properties of the media prevailing at the installation site of the measuring transducer. For position-dependent acquisition of the properties of the medium, a multiplicity of measuring transducers are required which respectively need to be installed at the sites where measurement values are to be acquired. This procedure, however, is very elaborate.

WO 2007/061306 A1 discloses a control system for process technology plants, which comprises sensors and actuators that float movably in a medium. The sensors described therein are likewise measuring transducers that are used to acquire a physical or chemical quantity of the medium. Position-dependent acquisition of a physical or chemical quantity of the medium is possible in this way, and processes in which the process medium is, for example, not homogeneously mixed, or in which locally different process conditions occur, can be managed better. As a result, an overall increase in the quality of the products produced is achieved.

Although the known measuring transducer is provided with an energy store to supply it with the energy required for operation, a substantial part of the stored energy is consumed for a measurement run by a drive device, which is used to move the measuring transducer in the medium. The energy store therefore frequently needs to be replaced, or recharged in the case of a chargeable store. This entails high maintenance outlay and the working times of the measuring transducer are thereby limited.

WO 2009/033496 A1 likewise discloses measuring transducers which can be placed movably in a liquid medium for measurement value acquisition. In order to reduce the energy that is required for movement of the measuring transducer in the medium, the density of the measuring transducer is adjustable. If the density of the measuring transducer differs from the density of the medium, measurement runs of the measuring transducer can be performed virtually without consumption of operating energy. In this case, exclusive use of the difference between the weight of the measuring transducer and the upthrust force generated by its displacement in the medium allows limited control of the rate of movement achieved. If the density of the measuring transducer is variable during a measurement run, for example, by altering the displacement volume of the measuring transducer by a gas bladder with adjustable volume, then by precise adjustment of the density of the measuring transducer to the density of the medium it is possible to make the measuring transducer remain at a desired position for a particular period of time, in order to obtain a time profile of the physical or chemical quantity to be measured from this location. As a way to output the position-dependently determined measurement value(s), a radio interface, for example, on a device for controlling the process taking place in the container is used. Examples mentioned are ultra-wideband, Bluetooth, Wireless Local Area Network (WLAN), ZigBee or Radio-Frequency Identification (RFID) interfaces. The output of the measurement values may occur directly in situ, or the measurement values may be temporarily stored while being provided with time and position in the measuring transducer and transferred after a preferred communication position has been reached. Output of the measurement values directly in situ has the advantage that the measurement values are available for further processing without delay, for example, in order to manage a process occurring in a reactor. In this way, it is possible to react very rapidly to changes. The localization of the measuring transducer is performed with the aid of the radio signals transmitted or received by the radio interface. Such localization is possible with many known transmission standards. The various measurement values may thus be assigned the position of their acquisition, so that a profile of the respective physical or chemical quantity as a function of position can be obtained.

Although measuring transducers which are movable in the medium are already known, possible foam formation is at present usually detected by visual inspection through a viewing window fitted on the container. This monitoring is particularly important for two reasons. On the one hand, foam formation in processes is an indication of suboptimal process running and, on the other hand, the foam present can lead to vitiations in the filling level measurement. Visual inspection by operating personnel is comparatively elaborate. In many cases information about possible foam formation on a liquid is therefore entirely ignored for cost reasons, although this means that the possible process optimization associated therewith is also lost.

### SUMMARY OF THE INVENTION

It is an object of the invention to provide a measuring transducer which can be placed movably in a liquid, and is capable of detecting foam formation on a liquid in a comparatively simple manner.

This and other objects and advantages are achieved in accordance measuring transducer with the invention by providing measuring transducers whose density is predetermined or adjustable such that they float movably on the surface of the liquid in which they are placed. This may, on the one hand, be achieved by measuring transducers whose density is already established during their production as a function of the respective liquid in which the measuring transducers are intended to be placed, and is therefore predetermined. On the other hand, the measuring transducers may be equipped with a way to variable adjust their density, so that they can vary the density during their use in situ. Both embodiments make it possible to form measuring transducers such that they assume positions at interfaces between different aggregate states of a medium owing to their density. Advantageously, this is performed without a drive device and therefore without the associated additional energy consumption.

On its upper side, the measuring transducer comprises a device for determining the incident luminous flux. By evaluating the luminous flux, it is possible to establish in a particularly simple way whether foam has formed on the interface on which the measuring transducer is located. Specifically, when defined light conditions are provided in the environment of the measuring transducer, it is possible to establish by use of a simple photosensitive sensor unit whether the light is only reaching the measuring transducer after having been attenuated, and it is therefore covered with foam. Reliable information about possibly existing foam formation is important for process management in many processes. Furthermore, the accuracy of a filling level measurement can be improved with the aid of the information about foam formation.

The photosensitive sensor unit preferably comprises a photodiode, or alternatively a phototransistor, which is incorporated into the surface of the measuring transducer, such that a vertical orientation upward is ensured with respect to the photosensitivity. In this direction, above the measuring transducer, there is preferably a defined light source that emits monochromatic light. According to the Beer-Lambert law, the thickness and concentration of a foam layer above the photosensitive sensor unit cause an exponential decrease in the light intensity which reaches the sensor unit. This law generally applies for the decrease in intensity of radiation propagating in attenuating substances, and constitutes the relationship for calculating the thickness of a foam layer which is present, as a function of the attenuation of optical radiation in the light-attenuating foam. With knowledge of the intensity of the unattenuated luminous flux and of the luminous flux reaching the sensor unit, the thickness of the foam can therefore be determined with the aid of this relation.

Particularly reliable information about the presence of a foam layer can therefore be obtained when the threshold value, below which the presence of foam is deduced, is specified as a function of a calibration value determined in the foam-free state.

In a particularly advantageous embodiment, the threshold value is additionally specified as a function of a further calibration value, which has been determined in the presence of foam having previously known properties. From the two values, it is advantageously possible to determine an extinction coefficient that is used in the Beer-Lambert law as a parameter for characterizing the attenuating properties of the foam. With this knowledge, quantitative information about the thickness of a foam layer is advantageously possible. With a suitably selected working point for the photosensitive sensor unit, it is possible to obtain a measurement signal from the incident light which is approximately proportional to the intensity of the incident light over a large range.

The density of the measuring transducer will be selected so that it lies on the interface and is only partially immersed in the liquid having the higher density.

To this end, the density of the measuring transducer is adjusted so that it lies between the higher density of the medium lying underneath at the interface and the lower density of the medium lying on top of the interface. The measurement principle of the density acquisition is based on the fact that, for example, at an interface between the gaseous and liquid aggregate states of a medium, the measuring transducer is immersed in the liquid until the weight force of the displaced liquid corresponds to the weight force of the measuring transducer. The lower the density of the liquid, the further the measuring transducer with the same weight will be immersed therein. With knowledge of the shape of the measuring transducer, its weight and the density of the medium of lower density lying on top of the interface, which is, for example, negligibly low in the case of a gaseous medium, as well as the immersion depth in the medium of higher density, it is therefore possible to deduce the density of the medium of higher density.

The weight of the measuring transducer can be calculated straightforwardly as the product of its density and its volume. Consequently, as an equivalent alternative it is of course possible to calculate the density of the heavier medium based on the latter values instead of the measuring transducer weight.

The immersion depth of the measuring transducer in the heavier liquid may be determined automatically by providing a suitable sensor unit on the surface of the measuring transducer or inside it. In both cases, one or more sensors may essentially determine the height of the heavier liquid on the measuring transducer housing, the measuring principle of which sensors is based on optical effects, for example, on the conductivity of the liquid when using photoresistors, phototransistors or photodiodes, or on capacitive effects. A relatively high accuracy with comparatively low energy outlay for the sensor unit is to be expected when using capacitive effects. To this end, a riser tube is preferably used that emerges from the measuring transducer housing at the bottom and top so that the immersion depth is reflected in a corresponding filling level or height change in the riser tube. The riser tube is arranged in a capacitor, the capacitance of which likewise changes with filling level variations in the tube. Reasons for this are the different dielectric constants of the medium of higher density and the medium of lower density. As an alternative, of course, the riser tube may be placed in a plurality of capacitors, each of which acquires a section of the riser tube.

The calculation of the density ρ_{F} of the liquid medium will be explained in more detail below with reference to the example of a spherical measuring transducer, for the case of an immersion depth which is less than its radius, and an interface between gaseous and liquid aggregate states of a medium. The density ρ_{F} may be calculated, with the aid of the mass M_{S} of the measuring transducer and with the aid of its displacement volume V₀ in the liquid medium, as:

ρ_{F}=M_{S}/V₀.

For the spherical measuring transducer, the displacement volume V₀ can be calculated as:

V₀=(πh²(3r−h))/3

with
h being the immersion depth and
r being the radius of the spherical measuring transducer.

The given formulae are merely exemplary for a spherical measuring transducer. It should be appreciated that with another shape of the measuring transducer, the dependency of the displacement volume on the immersion depth is of course different. It can, however, always be expressed as a formula or alternatively as an empirically determined characteristic line. When the density of the medium lying on top of the interface can no longer be neglected, the measuring transducer's displacement volume lying above the interface should also be included in the calculation of the density of the heavier medium.

Since the density of the measuring transducer ensures that it lies in the region of the interface, by localizing the measuring transducer it is possible to determine the position of the interface and therefore perform a filling level measurement. When using a measuring transducer that has a radio interface for communication with one or more base stations, the localization may, for example, be determined with the aid of the time of flight of the radio signals and the known geometrical proportions in the arrangement of the measuring transducer and the base stations. Finally, the filling level of the heavier medium in a container is obtained from the determined position of the measuring transducer.

Besides the density of the heavier medium, the measuring transducer lying on its surface may also transmit additional measurement values for further physical or chemical quantities, such as the temperature or electrical conductivity, to a device for controlling the process in which the measuring transducer is located. A radio interface allows virtually immediate transmission of the measurement values determined. For many applications, a simpler variant is of course suitable in which wireless communication is obviated and the measurement values are merely determined and stored in the measuring transducer over a particular period of time. After the end of the measurements, the measuring transducer is then removed from the process and the recorded data may be read out for evaluation, for example, over a communication jack.

Particularly reliable determination of the immersion depth and detection of foam formation are made possible when a unique orientation of the measuring transducer in the floating state is dictated by the position of the center of mass of the measuring transducer in the measuring transducer housing. This may, for example, be achieved by measuring transducers that consist partially of very high-density material and have a hollow space lying off-center. This leads to a center of mass also lying off-center which, for example, in the case of a floating spherical measuring transducer, comes to lie vertically below the midpoint of the measuring transducer.

Very accurate results in the density determination can also be achieved at interfaces between two liquid media of different density when the housing of the measuring transducer has a stable external shape overall, and there is a container inside the housing that is used for adjustment of the density of the measuring transducer. Preferably, a way is provided to adjust the density, by which liquid can be introduced into the container or liquid can be extracted from the container. Specifically, the measuring transducer has an average density that depends on the ratio between the hollow space in the container, the liquid-filled region of the container and the measuring transducer's constituent material which has a comparatively high density. Through a narrow channel, which preferably points vertically downward and therefore ensures that the container can be filled with liquid of the higher density, liquid of the higher density can be pumped in or pumped out. The adjustment of the container filling may, for example, be performed by a valve and/or a micropump, which are driven in a suitable way. With such a configuration of a measuring transducer, it can deliberately change its density by taking in or discharging the liquid medium. In order to increase the density, medium is pumped into the container and, for reducing the density, the medium is pumped out again. This allows “sinking” or “rising” from one interface to the next, for example, when a plurality of media each having a different density are layered above one another in a reactor. It is therefore possible to determine the respective density of the various media successively. Furthermore, other physical or chemical properties can be measured in a controlled way at different positions in the reactor by measuring transducers having an adjustable density. It is therefore possible to perform a measurement by a single measuring transducer at different positions with a different density, so that the number of measuring transducers required is reduced. On the other hand, a plurality of measuring transducers with a differently adjusted density can perform measurements at different positions in the medium simultaneously. A group of measuring transducers may be configured automatically by the built-in wireless communication so that all relevant positions in the medium are occupied by measuring transducers. This may, for example, be achieved by configuring, with one measuring transducer as the master, all neighbors within range with different values of the density to be adjusted, so that these thereupon take in the respectively suitable amount of medium into their containers in order to adjust the desired density. In a process medium that exists essentially in the three aggregate states, gas, liquid and solid, such measuring transducers offer the possibility of first placing them movably in the liquid with a density that is lower than that of the liquid medium. With this adjustment, measurements are first performed at the interface between the gaseous and liquid aggregate states. By determining the immersion depth, the density in the liquid aggregate state is additionally determined and reported as a measurement value to a process controller. Liquid can subsequently be pumped into the container of the measuring transducer and its density increased above that of the liquid medium. This leads to immersion of the measuring transducer as far as the boundary with the solid aggregate state. After the immersion, physical or chemical quantities at the boundary between the liquid and solid aggregate states can be acquired with the same measuring transducer. If need be, it is also possible to return the measuring transducer to the interface between the gaseous and liquid aggregate states by pumping out the medium previously taken into its container.

In a particularly advantageous embodiment, the housing of the measuring transducer is essentially spherical and has a diameter of between 5 and 10 cm. Such a measuring transducer is distinguished by particularly easy handling when placing it in the process and removing it therefrom, and offers sufficient space for the various components of the measuring transducer. The risk of the measuring transducer sticking or wedging in a container or tube is particularly low owing to its spherical shape. Furthermore, the formula already mentioned above for the dependency of the displacement volume on the immersion depth of the measuring transducer, which is comparatively simple to calculate, can be specified.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and configurations and advantages will be explained in more detail below with the aid of the drawings, in which exemplary embodiments of the invention are represented, in which:

FIG. 1 shows a schematic block diagram of a measuring transducer in accordance with the invention;

FIG. 2 shows a cross-sectional representation of a measuring transducer having an adjustable density in accordance with the invention;

FIG. 3 shows a measuring transducer with detection of foam formation; and

FIG. 4 shows a cross-sectional representation of a measuring transducer to explain the device for determining the immersion depth.

### DETAILED DESCRIPTION OF THE PREFERRED EMBODIMENTS

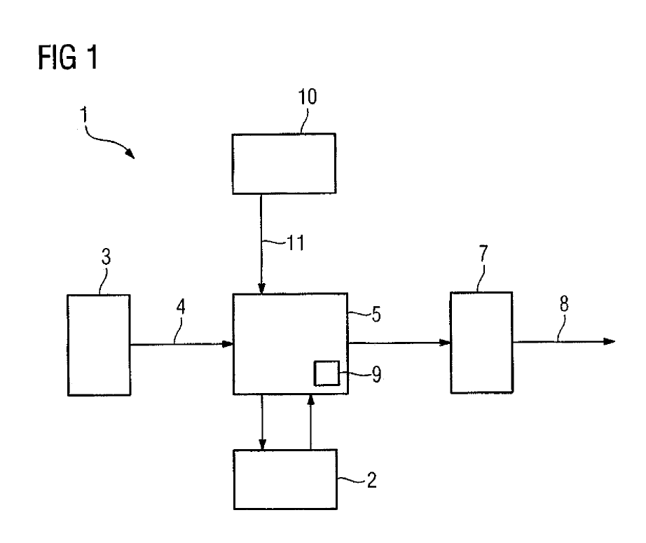

FIG. 1 represents a schematic block diagram of a measuring transducer 1. It is equipped with a device 2 for adjusting the density of the measuring transducer 1, which can be driven by a drive and evaluation device 5 and returns a signal thereto to indicate the currently adjusted density. With the aid of a sensor 3, the respective immersion depth of the measuring transducer 1 in a medium is acquired. The sensor 3 delivers a measurement signal 4, which corresponds to the respective immersion depth, to the drive and evaluation device 5.

With the aid of a photodiode 10, the luminous flux incident on the upper side of the measuring transducer 1 is detected and a corresponding signal 11 is sent to the drive and evaluation device 5. Further sensors of the measuring transducer 1, which are used to acquire further physical or chemical quantities of the medium, are not represented in FIG. 1 for the sake of clarity. From the measurement signal 4 and the respectively adjusted density of the measuring transducer 1, the drive and evaluation device 5 calculates a measurement value for the density of a medium in which the measuring transducer 1 is placed floating. The measurement value is temporarily stored in a memory 9 together with an indication of the location where the measuring transducer 1 is located at the instant of the measurement, and the time of the measurement. Calibration and threshold values determined when setting up the measuring transducer 1 are also stored in the memory 9. By a communication interface 7, which is configured as a wireless radio interface, the determined measurement value is forwarded over a radio link 8 as an indication signal, the content of which corresponds to the respective measurement value, to a reading device (not shown in FIG. 1). The location of the measurement is determined by a localization device, for example, by a GPS receiver or another radio localization device. The information obtained with the aid of the measuring transducer 1 about the density of the medium may be used for improved management of a process in which the medium density is acquired with the aid of the measuring transducer 1. The same applies for information about the presence of foam formation, which is obtained by threshold value comparison of the signal 11 and is likewise forwarded over the radio link 8.

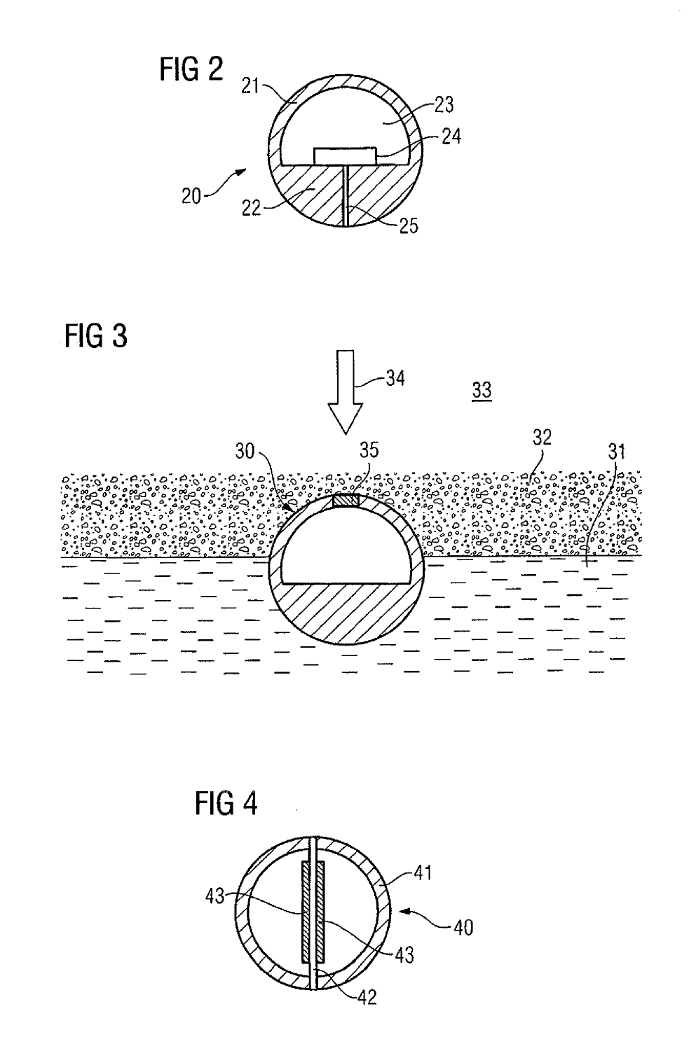

The principle of the adjustable density of a measuring transducer 20 will be explained in more detail with the aid of FIG. 2. The housing 21 of the measuring transducer 20 is made of a material, such as stainless steel, which has a comparatively high density. A unique orientation of the measuring transducer 20 is achieved by providing a thickening 22 of the housing in the lower region of its housing 21, so that the center of mass of the measuring transducer 20 is shifted downward away from the midpoint. This leads to a unique orientation of the measuring transducer 20 in the floating state. In the upper region of the measuring transducer 20, there is a container 23 which can hold a liquid medium or can be fully emptied. In order to fill or empty the container 23, a micropump 24 is provided that is connected to the surroundings through a channel 25, which emerges from the housing 21 at the lowermost point.

The micropump 24 is formed such that a liquid medium, in which the measuring transducer 20 is placed floating, can be pumped through the channel 25 into the interior of the container 23 to increase the density of the measuring transducer 20, or can be discharged again therefrom into the surroundings to lower the density of the measuring transducer 20. The measuring transducer 20 is therefore capable of varying its density in a wide range and adapting it to the respective working case.

The principle of the foam detection will now be explained with the aid of FIG. 3. A spherical measuring transducer 30, again with a low-placed center of mass to stabilize its orientation, is placed floating in a liquid medium 31. Above the liquid medium 31, a foam layer 32 has formed, over which in turn there is a medium 33 in the gaseous state. A luminous flux, which is incident on the upper side of the foam layer 32, is symbolized by an arrow 34. In order to detect foam formation, the measuring transducer 30 is provided on its upper side with a photodiode 35, which acquires the intensity of the part of the luminous flux 34 penetrating through the foam layer 32 and reaching the photodiode 35. With defined light conditions, the thickness of the foam layer 32 can be deduced with the aid of the received light intensity owing to a previously known attenuation of the light in the foam layer 32. If the detected luminous flux falls below a predetermined threshold value, then a signal to indicate unacceptably strong foam formation is output by the measuring transducer 30, for example, via the radio interface 7 (FIG. 1), and suitable measures to remedy the anomalous state can be implemented without delay.

FIG. 4 serves to explain an advantageous device for automatically determining the immersion depth of a measuring transducer 40. Inside the measuring transducer housing 41, a vertically oriented riser tube 42 is arranged, which emerges freely from the housing 41 both on the lower side of the measuring transducer 40 and on its upper side. According to the immersion depth of the measuring transducer 40 in a liquid medium, a “height” is set up in the riser tube 42, i.e., a vertical position of an interface in the riser tube 42. As a function of this height and the different dielectric constants of the media which meet one another at the interface, the capacitance of a capacitor 43 which is constructed around the riser tube 42 changes. The capacitance change may, for example, be acquired as a shift in the resonant frequency of a tuned electrical circuit and evaluated in the drive and evaluation device 5 (FIG. 1). Such a device for determining the immersion depth is distinguished by high accuracy and comparatively low energy consumption.

As an alternative to this, it is of course also possible to evaluate other physical effects, for example, refraction of light due to different refractive indices of the various media, by replacing the capacitor 43 with a photodiode array located at the same place and by making the riser tube 42 transparent.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A measuring transducer for detecting formation of foam on a liquid, the measuring transducer being movably placeable in the liquid and a density of which is one of predetermined and adjustable such that the measuring transducer floats on a surface of the liquid, comprising:
a device configured to determine a luminous flux incident on an upper side of the measuring transducer; and
an evaluation device arranged in the measuring transducer and formed so as to output a signal to indicate foam formation on the liquid when the determined luminous flux falls below a specified threshold value.

11. The measuring transducer as claimed in claim 10, wherein the device configured to determine the luminous flux incident comprises one of a phototransistor and a photodiode.

12. The measuring transducer as claimed in claim 10, wherein the threshold value is specified as a function of a calibration value determined in a foam-free state.

13. The measuring transducer as claimed in claim 11, wherein the threshold value is specified as a function of a calibration value determined in a foam-free state.

14. The measuring transducer as claimed in claim 12, wherein the threshold value is additionally specified as a function of a further calibration value determined in a presence of foam having previously known properties.

15. The measuring transducer as claimed in claim 10, further comprising:
means for automatically determining an immersion depth of the measuring transducer in the liquid and for generating a corresponding measurement signal;
wherein the evaluation device arranged in the measuring transducer is further formed so as to calculate a measurement value for the density of the liquid as a function of the measurement signal and the density of the measuring transducer, and to output a signal to indicate a value of the measurement signal.

16. The measuring transducer as claimed in claim 15, wherein the means for determining an immersion depth comprises:
a riser tube arranged inside a housing of the measuring transducer housing and extending from a lower side of the housing to an upper side of the housing for automatic determination of the a depth of immersion of the measuring transducer, the riser tube being incorporated in at least one capacitor so that a capacitance of the at least one capacitor is dependent on the immersion depth of the measuring transducer.

17. The measuring transducer as claimed in claim 16, wherein a unique orientation of the measuring transducer in the floating state is dictated by a position of a center of mass of the measuring transducer in the housing of the measuring transducer housing.

18. The measuring transducer as claimed in claim 16, further comprising:
a container arranged inside the housing of the measuring transducer; and
means for introducing liquid into the container or extracting liquid from the container;
wherein the housing of the measuring transducer has a stable external shape.

19. The measuring transducer as claimed in claim 18, wherein the housing of the measuring transducer is essentially spherical and has a diameter of between 5 and 10 cm.
